(19) United States
(12) Patent Application Publication
(10) Pub. No.: US 2007/0266580 A1
(43) Pub. Date: Nov. 22, 2007

(54) Tool and method for making a ventral opening in a vertebra

(75) Inventor: Arnold Keller, Kayhude (DE)

Correspondence Address: MORRISON & FOERSTER LLP, 1650 TYSONS BOULEVARD, SUITE 400, MCLEAN, VA, 22102, US

(73) Assignee: Waldemar Link GmbH & Co. KG, Hamburg (DE)

(21) Appl. No.: 11/404,121

(22) Filed: Apr. 14, 2006

(51) Int. Cl. G01B 1/00

(52) U.S. Cl. 33/511

(57) ABSTRACT

A tool and method for making vertebral incisions which form the lateral surfaces of a ventral opening in a vertebra for receiving a prosthesis that partially replaces the vertebra includes use of a saw jig with fittings configured for attachment to at least one of two vertebrae positioned superiorly and inferiorly adjacent to the vertebra and with guide fittings to provide a cutter guide for the incisions.

### FIELD AND BACKGROUND OF THE INVENTION

The use of saw jigs for incisions in bones which are intended to work in conjunction with an endoprosthesis in a precisely fitting way is known. Before use, the saw jig is fixed in the correct position to the bone in which the incision is to be made. The same applies to saw jigs with which a suitable cavity is to be prepared in two adjacent vertebrae for the purposes of receiving a “cage” (U.S. Pat. No. 6,159,214, U.S. Pat. No. 5,772,661). When it is simply a matter of creating a ventral opening in one vertebra to take a prosthesis that will partially replace that vertebra, it seems logical to attach the associated saw jig to the vertebrae in question. These vertebrae are very small, however. The invention therefore seeks to find a way of attaching the saw jig in a clearer way.

### SUMMARY OF THE INVENTION

This is achieved by the means as disclosed herein. These enable the saw jig to be attached not to the affected vertebra itself, but to an adjacent vertebra, preferably to both adjacent vertebrae. The invention of this application also includes the corresponding method.

The use of the invention is particularly advantageous for prostheses that are intended not only to partially replace the affected vertebra but also to work in correct alignment with the adjacent vertebrae. An example of such prostheses are those which are intended to replace a vertebra in respect of the vertical force that has to be transferred by it and which in addition are connected to the adjacent vertebrae across at least one joint. Examples thereof are found in European patent applications 04022670 and 04022671.

The saw jig according to the invention is particularly suitable for cases where there is a need to make two incisions that converge toward one another toward the dorsal aspect.

To guide the saw, saw jigs usually have a slit or some other guide opening which is bounded on both sides. According to the invention, the saw jig is equipped merely with two lateral cheeks, the outsides of which form a one-sided guide for the saw only. If this were not the case, the ability to maintain a clear overview in the very limited confines of the surgical site and in respect of the small vertebrae would be excessively impaired.

The limited space of the surgical site and the smallness of the vertebrae mean that precise positioning when applying the saw jig is difficult. When applying the saw jig, it is necessary in particular to ensure that a clear overview is maintained on both sides. According to the invention, a holding instrument is provided whereby the saw jig can be held before and during its connection to the vertebrae. This holding instrument is preferably designed in such a way that it has two gripping heads which can be expanded between two lateral cheeks of the saw jig and which make a form closure with these. This ensures that the clear overview of the surgical site is not diminished at the side of the saw jig.

The invention also relates to a corresponding method. For an explanation, reference should be made to the above.

### BRIEF DESCRIPTION OF THE DRAWINGS

The invention is described in more detail below with the aid of the drawing, which illustrates an advantageous exemplary embodiment and its use.

FIGS. 1 and 2 show views from the ventral and cranial aspect, and

FIG. 3 shows a perspective view at an oblique angle from the top from the ventral aspect with the placement instrument attached.

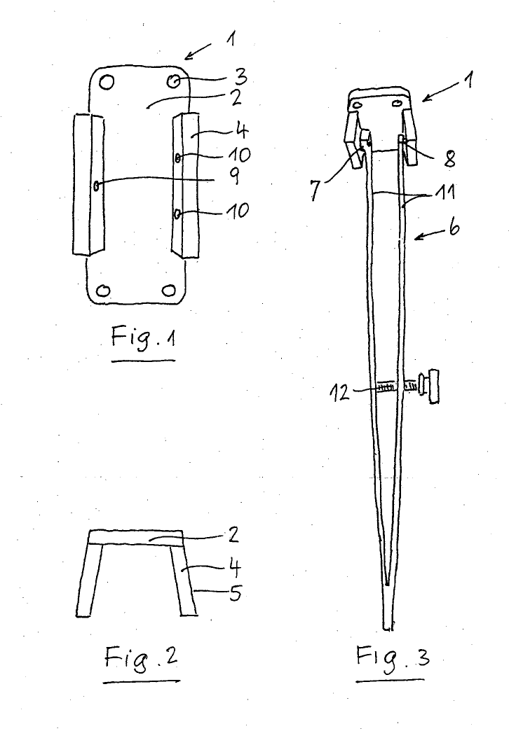

### DETAILED DESCRIPTION OF THE INVENTION

The saw jig 1 includes a base plate 2 which is to be applied, from the ventral aspect, to the vertebra to be worked on and to the superiorly/inferiorly adjacent vertebrae. At the top and bottom end there are screw holes 3 with which to secure the jig to the superior/inferior vertebrae.

In the middle area of the base plate 2, which corresponds to the vertebra to be worked on, two lateral cheeks 4 project from the base plate, the cheeks lying immediately adjacent to the lateral edges of the base plate. Their outer surfaces 5 serve as a guide for the saw when the vertebra is being incised. It will be seen that these surfaces 5 converge toward the dorsal aspect. The vertebral incisions made with their aid thus together form a “V” shape.

The saw may have a stop (not shown) which, in conjunction with the anterior edge of the lateral cheeks 4, prevents the saw jig from penetrating too far into the vertebra.

To make the saw jig 1 easier to use, an instrument 6 with which the saw jig can be held before and during its connection to the superior/inferior vertebra is provided. It must be easily detachable from the saw jig—there must be no need for the surgeon to handle the saw jig itself or the end of the instrument in the depth of the surgical site. For this purpose, the instrument has two gripping heads 7, 8 which are located at the end of expansible arms 11 and which can be connected to the saw jig by means of the expanding movement and detached from the saw jig by reversing the expansion. The cheeks 4 of the saw jig have holes on their inner side: one hole 9 in one cheek and two holes 10 in the other cheek. The gripping heads 7 have a corresponding pin (not shown) that fits into the hole 9, and the gripping head 8 has two corresponding pins (not shown) that fit into the holes 10. Between the arms 11 there is an expansion screw 12 whereby the arms 11 can be expanded against their inherent elastic force. When the instrument needs to be detached from the saw jig, the screw 12 is loosened, with the result that the arms 11 and the gripping heads 7, 8 move closer together by virtue of their inherent elastic tension and the pins disengage from the holes 9, 10. In an alternative arrangement, the inherent tension of the arms may be expansive, and the instrument is detached by tightening the screw.

1. A tool for making vertebral incisions which form lateral surfaces of a ventral opening in a vertebra for receiving a prosthesis that partially replaces said vertebra, comprising a saw jig, fittings configured for attachment to at least one of two vertebrae that are superiorly or inferiorly positioned adjacent to the vertebra and guide fittings that are configured to provide guides for a cutter to produce the incisions.

2. The tool as claimed in claim 1, wherein the saw jig has fittings for attachment to both the superior adjacent vertebra and the inferior adjacent vertebra.

3. The tool as claimed in claim 1 or 2, wherein the guide fittings are arranged to so as to produce two incisions which converge toward one another toward the dorsal aspect.

4. The tool as claimed in claim 1 or 2, wherein the guide fittings are formed solely from outer surfaces of two lateral cheeks on the saw jig.

5. The tool as claimed in claim 1 or 2, further comprising a holding instrument configured for holding the saw jig before and during connection to the superiorly or inferiorly positioned vertebrae, the holding instrument being detachable from the saw jig.

6. The tool as claimed in claim 5, wherein the holding instrument comprises two gripping heads which can be expanded between two saw guide cheeks on the saw jig and which make a form closure with the saw guide cheeks.

7. A method for making vertebral incisions which form lateral surfaces of a ventral opening in a vertebra for receiving a prosthesis that partially replaces said vertebra, comprising attaching a saw jig to at least one of two vertebrae that are superiorly or inferiorly positioned adjacent to the vertebra, and making incisions guided along guide fittings on the saw jig to produce the lateral surfaces of the ventral opening in the vertebra.

8. The method as claimed in claim 7, comprising attaching the saw jig to both the superior adjacent vertebra and the inferior adjacent vertebra.

9. The method as claimed in claim 7 or 8, comprising cutting along the guide fittings in such a way that the incisions converge toward one another dorsally.

10. The method as claimed in claim 7 or 8, comprising guiding the incisions along outer surfaces of two lateral cheeks of the saw jig.

11. The method as claimed in claim 7 or 8, further comprising holding the saw jig with a holding instrument before and during the connection of the saw jig to the superior and/or inferior vertebra, and subsequently detaching the holding instrument from the saw jig.

12. The method as claimed in claim 7 or 8, further comprising expanding two saw guide cheeks of the holding instrument and producing a form-closure gripping of the saw jig with gripping heads of the holding instrument.
